(19) United States
(12) Patent Application Publication
(10) Pub. No.: US 2014/0279240 A1
(43) Pub. Date: Sep. 18, 2014

(54) DECOUPLED MARKETING OFFER AND PAYMENT VERIFICATION SYSTEM AND METHOD

(71) Applicant: SnapOne Inc., Princeton, NJ (US)

(72) Inventors: Matthew Hansen, Yardley, PA (US); Mark Russo, Belle Mead (NJ); Reji Baby, Freehold, NJ (US)

(73) Assignee: SnapOne Inc., Princeton, NJ (US)

(21) Appl. No.: 13/894,815

(22) Filed: May 15, 2013

Related U.S. Application Data
(60) Provisional application No. 61/800,974, filed on Mar. 15, 2013.

(51) Int. Cl. G06Q 20/02; G06Q 30/06

(52) U.S. Cl. CPC G06Q 20/02; G06Q 30/0619
USPC 705/26.44

(57) ABSTRACT

A decoupled marketing offer and payment verification system is disclosed. The system communicates with a client and a 3rd party billing provider in connection with the purchase of a product. The system includes a marketing agent configured to receive a context from the client and generate one or more eligible offers, each offer representing the terms of purchase of a product and having associated offer Id. The system also includes a billing agent configured to receive payment information and a selected offer Id and issue a payment request to the 3rd party billing provider. On condition of successful payment, the billing agent is configured to generate a ticket comprising the selected offer Id, the ticket binding the successful payment to the selected offer Id. The billing agent is configured to verify that the ticket is eligible for redemption and record that the ticket is redeemed.

### CROSS-REFERENCE TO PRIOR FILED APPLICATIONS

This application claims priority to earlier filed U.S. provisional application No. 61/800,974 filed Mar. 15, 2013, which is incorporated herein in its entirety.

### FIELD OF INVENTION

The present disclosure relates to electronic commerce systems. More particularly, the present disclosure relates to a system, a device and a method with decoupled offer and payment verification for high-integrity and versatile marketing, billing and product (goods/services) provisioning systems.

### BACKGROUND

Electronic commerce (e-commerce) payment systems have become increasingly popular. This is partially because of the widespread use of the internet-based purchases or subscriptions. A variety of devices may be used to initiate such e-commerce transactions. A wide variety of payment systems, e.g., credit cards, debit cards, charge cards, digital wallets, e-cashes, mobile payments and e-checks, are also available for such transactions.

When a user purchases or subscribes to a product (goods or services), the details of the purchase may vary along several dimensions, including but not limited to: price, feature set, payment method, payment schedule, applied discounts, currency, etc. Combinations of these may yield thousands or even millions of permutations that each may represent a contract between customer and merchant. Several 3rd Party Billing gateways may be needed in order to process different types of payment method, such as, credit card, mobile billing, paper check, etc. Offers for goods or services may be presented to users in one or more of several different client implementations. In some cases goods cannot be delivered to a customer at the same time that funds are collected, or a transaction might fail after billing but before provisioning resulting in the need for customer service to intervene. It would be desirable to provide systems and methods that ensure that all clients are integrated with all billing gateways and allow for the sale and guaranteed delivery of all relevant and eligible goods and services.

### SUMMARY OF THE INVENTION

A decoupled marketing offer and payment verification system is disclosed. The system communicates with a client and a 3rd party billing provider in connection with the purchase of a product (goods or services). The system includes a marketing agent configured to receive a context from the client and generate one or more eligible offers, each offer representing the terms of purchase of a product and having associated offer Id. The system also includes a billing agent configured to receive payment information and a selected offer Id and issue a payment request to the 3rd party billing provider. On condition of successful payment, the billing agent is configured to generate a ticket comprising the selected offer Id, the ticket binding the successful payment to the selected offer Id. The billing agent is configured to verify that the ticket is eligible for redemption and record that the ticket is redeemed.

The billing agent may be configured to receive payment information from a first client and redeem the ticket via a second client. The ticket may include a plurality of fields including the offer Id, redemption state and 3rd party billing provider metadata including transaction information for accessing 3rd party billing provider billing records. The ticket may also include fields including the date of issue, date of expiration and date of redemption. Each offer Id may be associated with a plurality of dimensions associated with the product. The dimensions may identify at least one of, product characteristics, billing methods, user platform, client platform, user location, marketing campaign.

A method of providing a decoupled offer and payment verification in connection with the purchase of a product is also disclosed. The method includes receiving a context from a client and generating one or more eligible offers, each offer representing the terms of purchase of a product and having associated offer Id. The method also includes receiving payment information and a selected offer Id and issuing a payment request to a 3rd party billing provider and on condition of successful payment, generating a ticket comprising the selected offer Id, the ticket binding the successful payment to the selected offer Id, verifying that the ticket is eligible for redemption and recording that the ticket is redeemed.

The method may also include receiving payment information from a first client and redeeming the ticket via a second client. The ticket may include a plurality of fields including the offer Id, redemption state and 3rd party billing provider metadata including transaction information for accessing 3rd party billing provider billing records. The ticket may also include fields including the date of issue, date of expiration and date of redemption. Each offer Id may be associated with a plurality of dimensions associated with the product. The dimensions may identify at least one of, product characteristics, billing methods, user platform, client platform, user location, marketing campaign.

A computer-readable medium having stored thereon a computer program for execution by a processor configured to perform a method of providing a decoupled offer and payment verification in connection with the purchase of a product is also disclosed. The method includes receiving a context from a client and generating one or more eligible offers, each offer representing the terms of purchase of a product and having associated offer Id. The method also includes receiving payment information and a selected offer Id and issuing a payment request to a 3rd party billing provider and on condition of successful payment, generating a ticket comprising the selected offer Id, the ticket binding the successful payment to the selected offer Id, verifying that the ticket is eligible for redemption and recording that the ticket is redeemed.

### BRIEF DESCRIPTION OF THE FIGURES

FIG. 1 is a block diagram showing a typical system that lacks a billing agent and marketing agent;

FIG. 2 is a block diagram showing a system including a billing agent and marketing agent with a reduced the number of edges in the system, resulting in reduced overall complexity;

FIG. 3a is a sequence diagram describing the functional flow of the system in a standard sequential flow scenario;

FIG. 3b is a sequence diagram describing the functional flow of the system in a disconnected flow scenario;

FIG. 4 is a use case diagram that illustrates how a user uses a client application to interface with the marketing agent and billing agent; and

FIG. 5 is a block diagram showing the structure of a ticket.

### DETAILED DESCRIPTION OF THE INVENTION

Disclosed is a new decoupled offer and payment verification system and method for high-integrity and versatile marketing, billing and product (goods/services) provisioning systems. The offer and payment system provides a mechanism for separating the collection of funds independently with respect to the delivery of goods or services. This is useful in several ways, for example, in cases where:
payment is made on one device and services are delivered via a different device, or
the transaction must recover when payment has been collected but the customer has not yet redeemed product, or
services are delivered because authority has been granted, irrespective of how or why that authority was granted—i.e., because a payment was made, or for other reasons.

As explained above, when a user purchases or subscribes to a product (goods or services), the details of the purchase might vary along several dimensions, including but not limited to: price, feature set, payment method, payment schedule, applied discounts, currency, etc. Combinations of these yield thousands or even millions of permutations that each might represent a contract between customer and merchant. Several 3rd Party Billing gateways may be used in order to process different types of payment method, such as, credit card, mobile billing, paper check, etc. Offers for goods or services may be presented to users in one or more of several different client implementations.

The term “client” as used herein encompasses the check-out process, e.g., shopping cart, that is configured for purchase of a product. A client can include, a desktop browser based web page, a mobile web page, a desktop product with in-application billing, a mobile device (Android, IPhone, etc.) with in-application billing, software providing purchasing options on, tablets, laptops, TVs, cars, etc., any software application that exposes one or many purchase options and allows a user to execute on one of the purchase options. In some cases goods cannot be delivered to a customer at the same time that funds are collected, or a transaction might fail after billing but before provisioning resulting in the need for customer service to intervene. This results in substantial complexity in ensuring that ALL clients are integrated with all billing gateways to allow for the sale and guaranteed delivery of all relevant and eligible goods and services.

The disclosed offer and payment verification system addresses the problems set out above by:
separating the process associated with defining a product and its price from that which facilitates payment;
separating the process associated with collecting money from that which delivers purchased products (goods or services) to a customer; and
introducing layers of indirection—a marketing agent and a billing agent—between the product and client, and client and billing subsystems respectively. The marketing agent is responsible for producing one or more eligible offers that a client may use for a purchase transaction to be made against the billing agent.
The client does not need to know the nature of the offer used in this transaction. The client only needs to know how to reduce a set of eligible offers to a unique and unambiguous offer—and it does this by forcing the user to make a selection.
Once a singular offer has been identified it is handed over to the billing agent in order to initiate a transaction.
The billing agent makes a request for information about the offer to the marketing agent, passing the offer Id (or offer code) as a parameter. The marketing agent responds with all the offer information, including price, payment schedule, payment terms, contract duration, etc.
The billing agent does not have knowledge about products (goods or services); instead it serves to complete the billing transaction for whatever goods or services are represented by the offer.
Once payment has gone through, the billing agent registers this payment (including all metadata and 3rd party payment confirmation) with the Ticket Manager.
The Ticket Manager responds with a ticket as an internal record of receipt of funds. The ticket also references the original offer which identifies the goods and services that were purchased. The ticket represents a standardized internal currency within the business system and basically binds the successful payment to the selected offer Id.
Using this approach, no product (goods or services) can be issued to a customer in exchange for traditional payment. In order to redeem the item that was purchased, a valid ticket must be provided. In most cases this is done by a component in the system, such as a client application, for example.
Once a ticket has been issued, payment has been collected, and the user has entitlement to collect only those goods or services identified within the ticket.

FIG. 1 is a block diagram showing a typical system that lacks a billing agent and marketing agent. FIG. 1 demonstrates how the absence of the billing agent and marketing agent increases the complexity in the system due to a large number of edges between the business components. The system in FIG. 1 generally includes a plurality of goods/services that are available for purchase shown generally as products 20. The system also includes a plurality of client applications 22 that are configured to process transactions for the purchase of one or more of the products 20. The system also includes a plurality of 3rd party billing APIs 24 configured to accept various forms of payment. The variety communications paths between the various system components are shown lines identified by reference numbers 26 and 28. Reduction of this kind of complexity would be desirable.

FIG. 2 is a block diagram showing a decoupled system 100 including a billing agent 48 and marketing agent 44 with a reduced number of edges in the system, resulting in reduced overall complexity. The system in FIG. 2 generally includes a plurality of goods/services that are available for purchase shown generally as products 30. The system also includes a plurality of client applications 32 that are configured to process transactions for the purchase of one or more of the products 30. The system also includes a plurality of 3rd party billing APIs 34 configured to accept various forms of payment. The variety communications paths between the various system components are now routed through the billing agent 48 and marketing agent 44.

As explained above, the client 32 does not need to know the nature of the offer used in a given transaction. The client 32 only needs to know how to reduce a set of eligible offers to a unique and unambiguous offer—and it does this by forcing the user to make a selection. Once the user selection is received and a singular offer has been identified it is handed over to the billing agent 48 in order to initiate a transaction. The billing agent 48 may be implemented in hardware and software and may include a processor and memory as shown by block 47. The billing agent 48 transmits a request for information about the offer to the marketing agent 44. The request includes the offer Id as a parameter. The offer manager 42 communicates with the marketing agent 44 and generally disambiguates offers and decodes offer ID's. In the examples disclosed herein, the offer manager is shown separately from the marketing agent 44. It should be understood that the offer manager functionality may be integrated into the marketing agent 44. The marketing agent 44 receives the request and transmits a response with offer information, including price, payment schedule, payment terms, contract duration, etc. The marketing agent 44 may be implemented in hardware and software and may include a processor and memory as shown by block 43. The billing agent 48 does not have knowledge about products (goods or services); instead it is configured to complete the billing transaction for whatever goods or services are represented by the offer.

Once payment has gone through, the billing agent registers (transmits) the payment information (including all metadata and 3rd party payment confirmation) with the ticket manager 46. In the examples disclosed herein, the ticket manager 46 is shown separately from the billing agent. It should be understood that the ticket manager functionality may be integrated into the billing agent. The ticket manager 46 receives the payment information and transmits a ticket 50 in response. The ticket 50 functions as an internal record of receipt of funds. The ticket 50 also references the original offer which identifies the goods and services that were purchased. The ticket is typically transmitted to the client and ultimately to the user making the purchase. The ticket 50 generally represents a standardized internal currency within the system 100. Using this approach, no product (goods or services) can be issued to a customer in exchange for traditional payment. In order to redeem the item that was purchased, a valid ticket must be provided. In most cases this is done by a component in the system, such as a client application, for example. Once a ticket has been issued, payment has been collected, and the user has entitlement to collect only those goods or services identified within the ticket. The ticket basically binds the successful payment to the selected offer Id.

FIG. 3a is a sequence diagram describing the functional flow of the system and the role of each component in a standard sequential flow scenario. This scenario covers a situation in which the ticket is furnished and redeemed in a single step. For example, this would typically occur when a user is viewing a web site with a banner ad with a product offer. Clicking on the banner directs the user to a point of sale (POS) website to purchase the product. The user creates an account at the POS web site, furnishes all the required billing information, shipping/delivery information and the like and purchases the product.

The client 52 requests eligible offers from the marketing agent 64. The client also transmits a context so that the marketing agent can respond with a subset of all available offers based on the context. The context may include information relating to the client and/or user and/or geographic information so that the marketing agent eliminate offers that are not applicable. The marketing agent 64 responds with a listing of eligible offers, each offer having an associated offer Id. This exchange is generally shown by reference number 72. This information may be used e.g., to create a banner ad identified with an offer Id. The client is then configured to present these offers to one or more users. A user then requests to purchase the product associated with one of the offers as generally shown by reference number 80. The client 52 then forwards the purchase information to the billing agent 68. This information is used to provision the billing process. The billing agent requests offer detail from the marketing agent 64. The billing agent provides billing information to the 3^{rd} party billing API 54 and a purchase instruction is sent to the client 52 to set-up for the purchase. This exchange is generally shown by reference numbers 74 and 76. The purchase is then completed, e.g., a credit card number is supplied along with delivery/shipping information. Once payment is collected by the 3^{rd} party billing API 54, a ticket is generated by the ticket manager 66. As explained above, the ticket is an internal record of receipt of funds. The ticket also references the original offer which identifies the product that was purchased. The ticket represents a standardized internal currency within the system. The ticket basically binds the successful payment to the selected offer Id. The ticket is then redeemed by the billing agent and the product is then delivered, e.g., via download or is otherwise identified for shipping. A confirmation is returned to the client 52. This exchange is generally shown by reference number 78.

As explained above, in some cases goods cannot be delivered to a customer at the same time that funds are collected, or a transaction might fail after billing but before provisioning resulting in the need for customer service to intervene. FIG. 3b is a sequence diagram describing the functional flow of the system in a disconnected flow scenario. This scenario covers a situation in which the ticket is furnished and redeemed at a later time. For example, this would typically occur when a user is viewing a web site with a banner add with a product offer. Clicking on the banner directs the user to a point of sale (POS) website to purchase the product. The user may be using a mobile device and may choose not to create an account at the POS web site.

In this scenario, the client 52 requests eligible offers from the marketing agent 64. The client also transmits a context so that the marketing agent can respond with a subset of all available offers based on the context. The marketing agent 64 responds with a listing of eligible offers, each offer having an associated offer Id. This exchange is generally shown by reference number 172. This information may be used e.g., to create a banner ad identified with an offer Id. The client is then configured to present these offers to one or more users. A user then requests to purchase the product associated with one of the offers as generally shown by reference number 80. The client 52 then forwards the purchase information to the billing agent 68. This information is used to provision the billing process. The billing agent requests offer detail from the marketing agent 64. The billing agent provides billing information to the 3^{rd} party billing API 54 and a purchase instruction is sent to the client 52 to set-up for the purchase. This exchange is generally shown by reference numbers 174 and 176. The purchase is then completed, e.g., a credit card number is supplied along with delivery/shipping information. Once payment is collected by the 3^{rd} party billing API 54, a ticket is generated by the ticket manager 66. As explained above, the ticket is an internal record of receipt of funds. The ticket also references the original offer which identifies the product that was purchased.

As explained above, the ticket represents a standardized internal currency within the system. In this scenario, a billing confirmation and the ticket are forwarded to the client 52. The ticket is ultimately forwarded to the user. This exchange is generally shown by reference number 178. The user may then redeem the ticket at a later time. Ticket redemption by the billing agent and the product delivery, e.g., via download or shipping is generally shown by reference number 179. In this example, the business service provider 70 communicates with the billing agent to mark the ticket redeemed and facilitate and confirm delivery of the product based on the offer Id (by matching the offer Id to the corresponding product).

FIG. 4 is a use case diagram that illustrates how a user uses a client application to interface with the marketing agent and billing agent. The client 1 (151) is generally configured to present eligible product offers to a user and execute on an offer that is accepted by the agent. Client 2 (152) is configured to redeem purchases. It should be understood that one or more clients may be used to execute on offers and redeem purchases using a ticket as disclosed herein. A typical product may include goods or services. Several offers may be associated with this product, each having a unique offer Id, e.g., as set forth in Table 1 below:

TABLE 1
Example Products with Offer Ids

| | Variable | | |
|---|---|---|---|
| Product Description | Feature | Payment Method | Offer Id |
| On-Line Storage | 10 Gb | Credit | 100101 |
| On-Line Storage | 10 Gb | Bill to Mobile | 100102 |
| On-Line Storage | 10 Gb | Pay Pal | 100103 |
| On-Line Storage | 20 Gb | Credit | 100201 |
| On-Line Storage | 20 Gb | Bill to Mobile | 100202 |
| On-Line Storage | 20 Gb | Pay Pal | 100203 |
| On-Line Storage | 30 Gb | Credit | 100301 |
| On-Line Storage | 30 Gb | Bill to Mobile | 100302 |
| On-Line Storage | 30 Gb | Pay Pal | 100303 |

In the example in Table 1, the product is on-line storage and the offer Id varies in two dimensions depending on the storage capacity and payment method. It should be understood that a wide variety of products with variations in multiple dimensions may be used without departing from the scope of this disclosure. For example, dimensions may include product characteristics, billing methods, user platform, client platform, user location, marketing campaign and the like.

Once the user executes on an offer, the offer Id is used to identify the specific dimensions of the product that was purchased. The user may also redeem a purchase using a ticket that was generated during the processing of the order. In this example the user executes on the offer using client 1 (151) and then redeems using client 2 (152). Client 1 (151) has access to the marketing agent 164. The marketing agent 164 is generally configured to provide the available offers to client 1 (151) and also provide offer metadata to the billing agent 168 and ticket manager 166. The offer manager 162 communicates with the marketing agent 164 and generally disambiguates offers and decodes offer ID's. It should be understood that these offer manager functions may be implemented within the marketing agent.

The billing agent 168 is configured to collect funds when the user executes on an offer. The ticket manager 166 is configured to generate or record tickets, find tickets and provide ticket details to business service provider 170. Business service provider 170 is configured to deliver products via product provisioning module 180 and client 2 (152). In general, once the ticket is recorded it is communicated to the user via client 1 (151). The ticket or a confirmation code is then communicated to the user as generally shown by reference number 153. The user then redeems via client 2 (152) using the ticket or confirmation code.

FIG. 5 is a block diagram showing the structure of a ticket 250. The ticket generally includes a plurality of fields. In this example the ticket includes the following fields:
Date of issue;
Date of expiration;
Date of redemption;
Offer Id (the offer Id inherently describes the receivables redeemable for this ticket);
3rd Party Billing Provider Purchase Detail MetaData (This is a block of data that includes provider-specific subscription/payment information. The format will vary from provider to provider).

The following examples describe basic operation of the system.

### Example 1

1. A user is presented with an offer to buy or subscribe to Service X.

2. The offer is fully described by an offer Id that is issued by the marketing agent.

3. The user consents to purchasing Service X using his/her mobile device. The offer Id is passed to the billing agent in order to collect payment.

4. The user is billed via his mobile carrier prior to our having any record of them as a user in the Service X system.

5. As part of the billing transaction, a ticket is recorded that captures the metadata associated with the purchase.

6. At a later point, the user creates an account for Service X using their mobile device.

7. The ticket is recovered, payment verified, and the correct service is issued to the user based on the offer Id (by matching the offer Id to the corresponding product).

### Example 2

1. A user is presented with an offer to buy or subscribe to Service X.

2. The offer is fully described by an offer Id that is issued by the marketing agent.

3. The user consents to purchasing Service X using his/her mobile device. The offer Id is passed to the billing agent in order to collect payment.

4. The user is billed via his mobile carrier prior to our having any record of them as a user in the Service X system.

5. As part of the billing transaction, a ticket is recorded that captures the metadata associated with the purchase.

6. The user receives a confirmation code that acts as a unique reference to the recorded ticket.

7. The user signs up for Service X on his/her desktop computer using a web browser.

8. The user enters the confirmation code, and his/her ticket is recovered, payment verified, and the correct service is issued to the user based on the offer Id (by matching the offer Id to the corresponding product).

Some of the advantages provided by the system and method are as follows:
Reduced Complexity
The number of edges in the system is reduced and awareness is limited to whatever is relevant at each layer.
Client applications can limit their awareness and defer to the billing agent to seek out and consume all relevant information regarding what is to be sold (including product, price, features, etc.) simply by passing on the offer id.
The marketing agent can identify an eligible offer without any ‘knowledge’ about how payment might be collected;
Similarly, the client can execute on a purchase without any ‘knowledge’ about the product being sold; and by interfacing with the billing agent, there is no requirement for the client to have any ‘knowledge’ regarding the manner in which payment will be made via a particular 3^{rd} Party Billing Provider API.
Finally, the billing agent can execute on a purchase without any ‘knowledge’ about the product being sold; but can collect payment with reference to the parameters provided in the offer.
The provisioning system, responsible for issuing goods or service to a customer after payment is received, is no longer concerned with how payment was made, or even if payment was made. The only criterion that needs to be satisfied to redeem purchased goods, is that a valid ticket that is eligible for those services is provided.
This ensures that the complexity associated with the payment system does not corrupt the business services, and vice versa. Similarly, it allows for the reuse of the payment system to sell any type of product in any type of business.
Any transaction that is completed, in which payment was completed, is still susceptible to potential failure to deliver purchased goods. As long as a ticket has been issued, the transaction is able to be reestablished and completed in order to furnish a user with his purchased goods.
Improved System Integrity
Reduced Burden on Resources—Implementation and Maintenance
Reusable Infrastructure
Generic Solution for potential Resale or White-labeling.

It should be understood that many variations are possible based on the disclosure herein. For example, the embodiments disclosed above include the use of both an offer ID and a ticket for redemption. Systems may be implemented with just the ticket functionality without the use of the offer Id as disclosed above. Although features and elements are described above in particular combinations, each feature or element can be used alone without the other features and elements or in various combinations with or without other features and elements. The apparatus or methods disclosed herein may be implemented in a computer program, software, or firmware incorporated in a computer-readable (non-transitory) storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

What is claimed is:

1. A decoupled offer and payment verification system configured to communicate with a client and a 3^{rd} party billing provider in connection with the purchase of a product, the system comprising:
a marketing agent configured to receive a context from the client and generate one or more eligible offers, each offer representing the terms of purchase of a product and having associated offer Id;
a billing agent configured to receive payment information and a selected offer Id and issue a payment request to the 3^{rd} party billing provider and on condition of successful payment, the billing agent being configured to generate a ticket comprising the selected offer Id, the ticket binding the successful payment to the selected offer Id, the billing agent being configured to verify that the ticket is eligible for redemption and record that the ticket is redeemed.

2. The system of claim 1, wherein the billing agent is configured to receive payment information from a first client and redeem the ticket via a second client.

3. The system of claim 1, wherein the ticket comprises a plurality of fields including the offer Id, redemption state and 3^{rd} party billing provider metadata including transaction information for accessing 3^{rd} party billing provider billing records.

4. The system of claim 3, wherein the ticket further comprises fields including the date of issue, date of expiration and date of redemption.

5. The system of claim 1, wherein each offer Id is associated with a plurality of dimensions associated with the product.

6. The system of claim 1, wherein the dimensions identify at least one of, product characteristics, billing methods, user platform, client platform, user location, marketing campaign.

7. A method of providing a decoupled offer and payment verification in connection with the purchase of a product, the method comprising:
receiving a context from a client and generating one or more eligible offers, each offer representing the terms of purchase of a product and having associated offer Id;
receiving payment information and a selected offer Id and issuing a payment request to a 3^{rd} party billing provider and on condition of successful payment, generating a ticket comprising the selected offer Id, the ticket binding the successful payment to the selected offer Id, verifying that the ticket is eligible for redemption and recording that the ticket is redeemed.

8. The method of claim 7, further comprising receiving payment information from a first client and redeeming the ticket via a second client.

9. The method of claim 7, wherein the ticket comprises a plurality of fields including the offer Id, redemption state and 3^{rd} party billing provider metadata including transaction information for accessing 3^{rd} party billing provider billing records.

10. The method of claim 9, wherein the ticket further comprises fields including the date of issue, date of expiration and date of redemption.

11. The method of claim 7, wherein each offer Id is associated with a plurality of dimensions associated with the product.

12. The method of claim 11, wherein the dimensions identify at least one of, product characteristics, billing methods, user platform, client platform, user location, marketing campaign.

13. A computer-readable medium having stored thereon a computer program for execution by a processor configured to perform a method of providing a decoupled offer and payment verification in connection with the purchase of a product, the method comprising:
receiving a context from a client and generating one or more eligible offers, each offer representing the terms of purchase of a product and having associated offer Id;
receiving payment information and a selected offer Id and issuing a payment request to a 3^{rd} party billing provider and on condition of successful payment, generating a ticket comprising the selected offer Id, the ticket binding the successful payment to the selected offer Id, verifying that the ticket is eligible for redemption and recording that the ticket is redeemed.

14. The computer-readable medium of claim 13, further comprising receiving payment information from a first client and redeeming the ticket via a second client.

15. The computer-readable medium of claim 13, wherein the ticket comprises a plurality of fields including the offer Id, redemption state and 3^{rd} party billing provider metadata including transaction information for accessing 3^{rd} party billing provider billing records.

16. The computer-readable medium of claim 15, wherein the ticket further comprises fields including the date of issue, date of expiration and date of redemption.

17. The computer-readable medium of claim 13, wherein each offer Id is associated with a plurality of dimensions associated with the product.

18. The computer-readable medium of claim 17, wherein the dimensions identify at least one of, product characteristics, billing methods, user platform, client platform, user location, marketing campaign.
